(19) United States
(12) Patent Application Publication
(10) Pub. No.: US 2016/0283662 A1
(43) Pub. Date: Sep. 29, 2016

(54) SYSTEMS, METHODS, APPARATUSES, AND COMPUTER PROGRAM PRODUCTS FOR PROVIDING AN INTERACTIVE, CONTEXT-SENSITIVE ELECTRONIC HEALTH RECORD INTERFACE

(71) Applicant: McKesson Corporation, San Francisco, CA (US)

(72) Inventor: Suresh Batta, Albany, CA (US)

(21) Appl. No.: 14/671,113

(22) Filed: Mar. 27, 2015

(51) Int. Cl. G06F 19/00

(52) U.S. Cl. CPC G06F 19/322; G06F 19/3487

(57) ABSTRACT

Systems, methods, apparatuses, and computer program products are provided for providing an interactive, context-sensitive electronic health record interface. In this regard, an example of an electronic health record interaction system may include at least one processor which may cause the system to at least provide a record including a plurality of information nodes of a graph associated with a patient, receive a request for review at a first user terminal of the record from a first user having a first identity, and establish information nodes associated with a role of the first user. A query may be generated of the information nodes associated with the role of the first user, and a first subset of information nodes of the information nodes associated with the role of the first user may be received based, at least in part, on the identity of the first user.

### TECHNOLOGICAL FIELD

Embodiments of the present invention relate generally to electronic medical records and, more particularly, to methods, apparatuses, and computer program products for providing an interactive, context-sensitive clinical record interface.

### BACKGROUND

The health care industry is moving toward maintaining health care records electronically. In this regard, the evolution of modern computing and networking technology has lead to a widespread adoption and increasing reliance on computers and associated software for facilitating patient treatment, maintaining patient treatment records, and for tracking and payment of charges attendant to patient treatment. For example, use of computing technology by health service providers has allowed for the creation and maintenance of electronic health record documents for patients, including medical treatment and diagnosis records, billing records, insurer explanation of benefits records, and payment records. Electronic maintenance of such records has offered several advantages to health service providers, including more ready access to patient health information and a reduction in reliance on cumbersome paper files, which may be burdensome to maintain and may be more susceptible to data loss than electronic systems.

While there has been a rapidly increasing reliance on electronic health records, the implementation of computer systems supporting electronic patient health records has largely been siloed within the confines of individual service providers. Adoption of electronic health records has largely been in the form of numerous proprietary systems internal to various providers, often having their own proprietary data formats, which have made exchange of information between providers difficult, and which have provided patients with little control over the privacy of their records.

### BRIEF SUMMARY

Systems, methods, apparatuses, and computer program products are herein provided for providing an interactive, context-sensitive electronic health record interface. In this regard, an example embodiment of an electronic health record interaction system for providing an interactive, context-sensitive electronic health record interface may include at least one processor. The at least one processor may cause the system to at least provide a record including a plurality of information nodes of a graph associated with a patient, receive a request for review at a first user terminal of the record from a first user having a first identity, and establish information nodes associated with a role of the first user. A query may be generated of the information nodes associated with the role of the first user, and a first subset of information nodes of the information nodes associated with the role of the first user may be received based, at least in part, on the identity of the first user. The first subset of information nodes may be provided for display on the first user terminal. According to some embodiments, a request for review at a second user terminal of the record may be received from a second user having a second identity. Information nodes associated with a role of the second user may be established, and a query may be generated of the information nodes associated with the role of the second user to receive a second subset of information nodes of the information nodes associated with the role of the second user based on the identity of the second user. The second subset of information nodes may be provided for display at the second user terminal, where the first subset of information nodes may be different from the second subset of information nodes.

According to some embodiments, the system for providing an interactive, context-sensitive electronic health record interface may further be configured to enable the first user to edit one or more of the first subset of information nodes and enable the second user to edit one or more of the second subset of information nodes. The first user may be precluded from editing one or more of the second subset of information nodes and the second user may be precluded from editing one or more of the first subset of information nodes. Each information node may include an informational element about the patient, where the first subset of information nodes includes one or more of current prescriptions for the patient, contact information for the patient, or future physician appointments for the patient. The second subset of information nodes may include one or more of laboratory results for the patient, diagnoses for the patient, or vital physiological statistics of the patient. The first subset of information nodes may be established based on relevance to the first user role and to the first user identity. According to some embodiments, the system may further be configured to enable the first user to select a second role, establish information nodes associated with the second role, generate a query of the information nodes associated with the second role to determine a third subset of information nodes of the information nodes associated with the second role based on the identity of the first user, and provide for display at the first user terminal of the third subset of information nodes.

Embodiments of the present invention may provide a method for providing an interactive, context-sensitive electronic health record interface. The method may include providing a record including a plurality of information nodes of a graph associated with a patient, receiving a request for review at a first user terminal of the record from a first user having a first identity, and establishing information nodes associated with a role of the first user. A query may be generated of the information nodes associated with the role of the first user and a first subset of information nodes of the information nodes associated with the role of the first user may be received based on the identity of the first user. The first subset of information nodes may be provided for display at the first user terminal. The method may include receiving a request for review at a second user terminal of the record from a second user having a second identity, establishing information nodes associated with a role of the second user, generating a query of the information nodes associated with the role of the second user and receiving a second subset of information nodes of the information nodes associated with the role of the second user based, at least in part, on the identity of the second user. The second subset of information nodes may be provided for display at the second user terminal, and the second subset of information nodes may be different from the first subset of information nodes.

According to some embodiments, the method may optionally include enabling the first user to edit one or more of the first subset of information nodes and enabling the second user to edit one or more of the second subset of information nodes. Optionally, the method may preclude the first user from editing one or more of the second subset of information nodes and preclude the second user from editing one or more of the first subset of information nodes. Each information node may include an informational element about the patient, where the first subset of information nodes includes one or more of current prescriptions of the patient, contact information for the patient, or future physician appointments of the patient. The second subset of information nodes may include one or more of laboratory results from the patient, diagnoses for the patient, or vital physiological statistics of the patient. The first subset of information nodes may be established based on relevance to the first user role and the first user identity. Methods may optionally include enabling the first user to select a second role, establishing information nodes associated with the second role, generating a query of the information nodes associated with the second role to determine a third subset of information nodes of the information nodes associated with the second role based, at least in part, on the identity of the first user, and providing for display at the first user terminal of the third subset of information nodes.

Embodiments of the present invention may provide a computer program product for providing network-accessible patient health records, with the computer program product including at least one non-transitory computer-readable storage medium having computer-readable program instructions stored therein. The computer-readable program instructions including: program instructions for providing a record having a plurality of information nodes of a graph associated with a patient; program code instructions for receiving a request for review at a first user terminal of the record from a first user having a first identity; program code instructions for establishing information nodes associated with a role of the first user, and program code instructions for generating a query of the information nodes associated with the role of the first user receiving a first subset of information nodes of the information nodes associated with the role of the first user based, at least in part, on the identity of the first user. The computer-readable program instructions may optionally include program code instructions for providing for display at the first user terminal of the first subset of information nodes, program code instructions for receiving a request for review at a second user terminal of the record from a second user having a second identity; program code instructions for establishing information nodes associated with a role of the second user; program code instructions for generating a query of the information nodes associated with the role of the second user and receiving a second subset of information nodes of the information nodes associated with the role of the second user based, at least in part, on the identity of the second user; and program code instructions for providing for display at the second user terminal of the second subset of information nodes. The first subset of information nodes being different from the second subset of information nodes.

According to some embodiments, the computer program product may include program code instructions for enabling the first user to edit one or more of the first subset of information elements and program code instructions for enabling the second user to edit one or more of the second subset of information elements. Embodiments may include program code instructions for precluding the first user from editing one or more of the second subset of information nodes and program code instructions for precluding the second user from editing one or more of the first subset of information nodes. Each information node may include an informational element about the patient, where the first subset of information elements includes one or more of current prescriptions for the patient, contact information for the patient, or future physician visits for the patient. The second subset of information nodes may include one or more of laboratory results for the patient, diagnoses for the patient, or vital physiological statistics for the patient. According to some embodiments, the computer program product may include: program code instructions for enabling the first user to select a second role; program code instructions for establishing information nodes associated with the second role; program code instructions for generating a query of the information nodes associated with the second role to determine a third subset of information nodes of the information nodes associated with the second role based, at least in part, on the identity of the first user; and program code instructions for providing for display at the first user terminal of the third subset of information nodes.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the invention in any way. It will be appreciated that the scope of the invention encompasses many potential embodiments, some of which will be further described below, in addition to those here summarized.

### BRIEF DESCRIPTION OF THE DRAWINGS

Having thus described embodiments of the invention in general terms, reference will now be made to the accompanying drawings, which are not necessarily drawn to scale, and wherein:

FIG. 1 illustrates a system for providing an interactive, context-sensitive electronic health record interface according to some example embodiments;

FIG. 2 illustrates a block diagram of a healthcare provider apparatus according to some example embodiments;

FIG. 3 illustrates a schematic of a display for providing an interactive, context-sensitive electronic health record interface as viewed from a first role and identity according to some example embodiments;

FIG. 4 illustrates an example embodiment of an information element or information node selection window;

FIG. 5 illustrates a schematic of a display for providing an interactive, context-sensitive electronic health record interface as viewed from a second role and identity according to some example embodiments;

FIG. 6 illustrates a flowchart of operations performed in connection with an interactive, context-sensitive electronic health record interface according to some example embodiments;

FIG. 7 illustrates an electronic health record graph comprising information nodes according to an example embodiment of the present invention;

FIG. 8 illustrates a schematic of a display for providing an interactive, context-sensitive electronic health record interface of a patient population as viewed from a second role and identity according to some example embodiments; and

FIG. 9 illustrates a flowchart according to a further example method for providing an interactive, context-sensitive electronic health record interface according to some example embodiments.

### DETAILED DESCRIPTION

Some embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

As used herein, the terms “data,” “content,” “information” and similar terms may be used interchangeably to refer to data capable of being transmitted, received, displayed and/or stored in accordance with various example embodiments. Thus, use of any such terms should not be taken to limit the spirit and scope of the disclosure. Further, where a computing device is described herein to receive data from another computing device, it will be appreciated that the data may be received directly from the another computing device or may be received indirectly via one or more intermediary computing devices, such as, for example, one or more servers, relays, routers, network access points, and/or the like.

Electronic health records (EHRs), also known as electronic patient health records, patient health records (PHR), or clinical health records, are becoming increasingly popular with the ubiquity of personal computers, tablet computers, and other digital devices used in the patient care environment. These electronic health records are useful tools for both physicians and patients, and can increase the portability of a patient's personal health record information while helping providers better understand a patient under their care due to the longitudinal health record information available in an electronic health record. The availability of this information also brings opportunity to streamline access to the electronic health record while maintaining patient privacy.

In this regard, some example embodiments provide patients with access to, and control over at least a portion of their own medical information by providing an interactive, context-sensitive electronic health record interface. More particularly, some example embodiments provide for secure storage of electronic health records that can be accessed by a patient or provider while providing only the information necessary to the viewer based on his/her identity, and reducing the amount of undesirable or unimportant information presented to a viewer based on his/her role and identity.

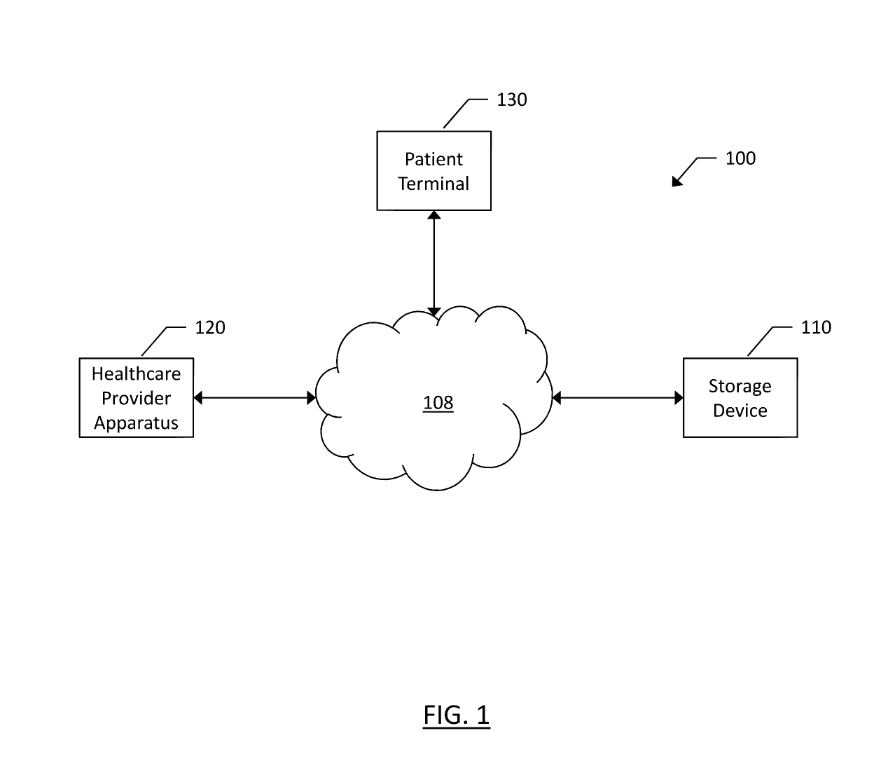

FIG. 1 illustrates a system 100 for providing network-accessible electronic health records according to some example embodiments. It will be appreciated that the system 100, as well as the illustrations in other figures, are each provided as an example of some embodiments and should not be construed to narrow the scope or spirit of the disclosure in any way. In this regard, the scope of the disclosure encompasses many potential embodiments in addition to those illustrated and described herein. As such, while FIG. 1 illustrates one example of a configuration of a system for providing an interactive, context-sensitive electronic health record interface for network-accessible electronic health records, numerous other configurations may also be used to implement embodiments of the present invention.

In the system of FIG. 1, electronic health records may be semantically networked. In this regard, in the system 100, a patient's electronic health records may exist in a secure database, accessible on a network, such as the internet. More particularly, patient electronic health record documents may be stored within a storage device 110 that may reside within or accessible through a network 108. The network 108 may comprise one or more wireless networks (e.g., a cellular network, wireless local area network, wireless metropolitan area network, and/or the like), one or more wireline networks (e.g., a wired local area network), or some combination thereof, and in some embodiments comprises at least a portion of the internet. It will be appreciated that the storage device 110 may comprise any location or plurality of locations on the network 108 on which patient electronic health record documents may be stored and accessed via a secure user interface. In this regard, the storage device 110 may be supported by a “cloud” computing model supporting dynamically scalable and highly virtualized storage resources. The system may include a healthcare provider apparatus 120 and/or a patient terminal 130, as will be described further below, where the patient terminal and the healthcare provider apparatus, referred to collectively as user terminals, are in communication over network 108 with the storage device 110.

Security of electronic health record documents stored within the storage device 110 may be maintained through a variety of available means. For example, a layered security approach may be employed with encryption keys, public key infrastructure (PKI), extensible markup language (XML) encryption, etc. The electronic medical record of a patient stored on storage device 110 may be accessible to authorized users, such as a patient's physician, a nurse of a practice associated with the patient, a specialist conducting a reading (e.g., a radiologist conducting a radiology read order) on the patient, an in-home care-giver for a patient, a parent or guardian of the patient, or the patient themselves. The physicians, nurses, specialists, or other healthcare providers that may be authorized to access the electronic health record of a patient may collectively be referred to herein as authorized healthcare providers. Authorized healthcare providers may access a patient's electronic health record stored on storage device 110 through, for example, healthcare provider apparatus 120.

The healthcare provider apparatus 120 may be embodied as any computing device or plurality of computing devices configured to perform at least some functionality of interfacing with an electronic health record as described herein. In this regard, the healthcare provider apparatus 120 may comprise an apparatus or plurality of apparatuses operated by an agency or entity interfacing with an electronic health record of a patient in accordance with one or more example embodiments. By way of non-limiting example, the healthcare provider apparatus 120 may be embodied as one or more servers, a server cluster, a cloud computing infrastructure, one or more network nodes, multiple computing devices in communication with each other, or any combination thereof, and/or the like. A healthcare provider apparatus 120 may be embodied as a computing apparatus at a physician's office, hospital, lab, therapist, pharmacy, insurance provider, patient guarantor, and/or other healthcare service provider. According to some embodiments, a healthcare provider apparatus 120 may include a personal computing device comprising sufficient security features to enable a healthcare provider access to a patient's electronic health record regardless of location, such as a remotely located radiologist performing a teleradiology study.

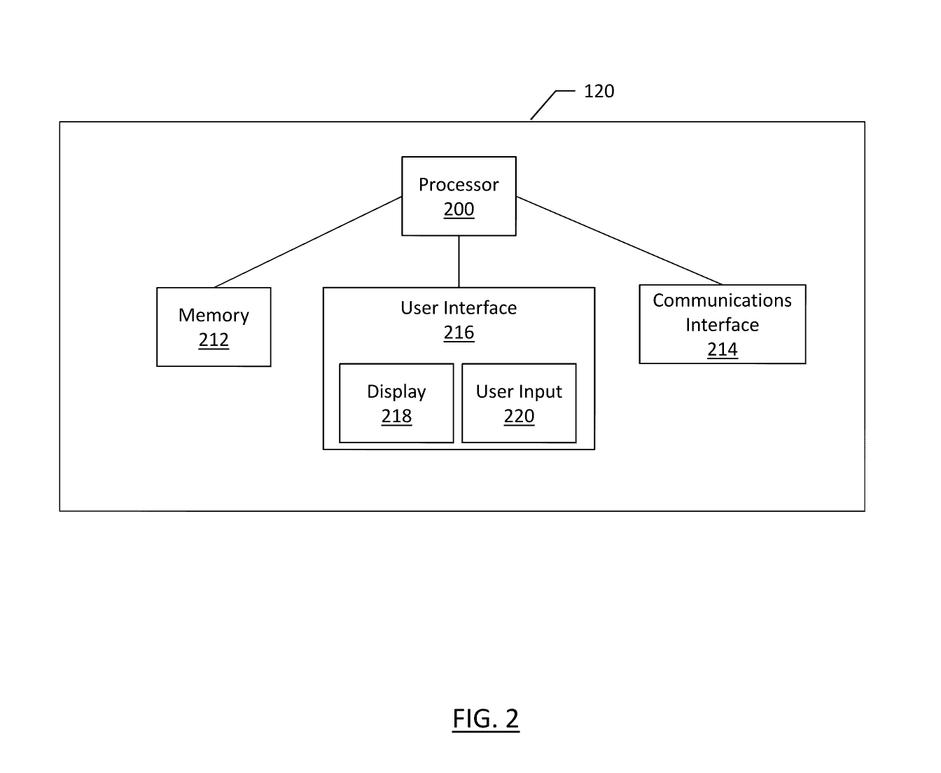

FIG. 2 illustrates a block diagram of a healthcare provider apparatus 120 configured to interface with an electronic health record according to an example embodiment. In some example embodiments, the healthcare provider apparatus 120 includes various means for performing the various functions described herein. These means may include, for example, one or more of a processor 200, memory 212, communications interface 214, and a user interface 216. The means of the healthcare provider apparatus 120 as described herein may be embodied as, for example, circuitry, hardware elements (e.g., a suitably programmed processor, combinational logic circuit, and/or the like), a computer program product comprising computer-readable program instructions (e.g., software or firmware) stored on a computer-readable medium (e.g. memory 212) that is executable by a suitably configured processing device (e.g., the processor 200), or some combination thereof.

The processor 200 may, for example, be embodied as various means including one or more microprocessors, one or more coprocessors, one or more multi-core processors, one or more controllers, processing circuitry, one or more computers, various other processing elements including integrated circuits such as, for example, an ASIC (application specific integrated circuit) or FPGA (field programmable gate array), one or more other types of processors implemented in hardware, or some combination thereof. Accordingly, although illustrated in FIG. 2 as a single processor, in some embodiments the processor 200 may comprise a plurality of processors. The plurality of processors may be embodied on a single computing device or may be distributed across a plurality of computing devices collectively configured to function as the healthcare provider apparatus 120. The plurality of processors may be in operative communication with each other and may be collectively configured to perform one or more functionalities of the healthcare provider apparatus 120 as described herein. In some example embodiments, the processor 200 is configured to execute instructions stored in the memory 212 or otherwise accessible to the processor 200. These instructions, when executed by the processor 200, may cause the healthcare provider apparatus 120 to perform one or more of the functionalities of the healthcare provider apparatus 120 as described herein. As such, whether configured by hardware or software methods, or by a combination thereof, the processor 200 may comprise an entity capable of performing operations according to embodiments of the present invention while configured accordingly. Thus, for example, when the processor 200 is embodied as an ASIC, FPGA or the like, the processor 200 may comprise specifically configured hardware for conducting one or more operations described herein. Alternatively, as another example, when the processor 200 is embodied as an executor of instructions, such as may be stored in the memory 212, the instructions may specifically configure the processor 200 to perform one or more algorithms and operations described herein.

The memory 212 may include, for example, volatile and/or non-volatile memory. Although illustrated in FIG. 2 as a single memory, the memory 212 may comprise a plurality of memories. The plurality of memories may be embodied on a single computing device or distributed across a plurality of computing devices. The memory 212 may comprise, for example, a hard disk, random access memory, cache memory, flash memory, an optical disc (e.g., a compact disc read only memory (CD-ROM), digital versatile disc read only memory (DVD-ROM), or the like), circuitry configured to store information, or some combination thereof. In this regard, the memory 212 may comprise any non-transitory computer readable storage medium. The memory 212 may be configured to store information, data, applications, instructions, or the like for enabling the healthcare provider apparatus 120 to carry out various functions in accordance with example embodiments of the present invention. For example, in some example embodiments, the memory 212 is configured to buffer input data for processing by the processor 200. Additionally or alternatively, in some example embodiments, the memory 212 is configured to store program instructions for execution by the processor 200. The memory 212 may store information in the form of static and/or dynamic information. For example, the memory 212 may store symmetric encryption/decryption keys that may be used to encrypt/decrypt electronic health record documents. This stored information may be stored and/or used by the processor 200 during the course of performing its functionalities.

The communication interface 214 may be embodied as any device or means embodied in circuitry, hardware, a computer program product comprising computer readable program instructions stored on a computer readable medium (e.g., the memory 212) and executed by a processing device (e.g., the processor 200), or a combination thereof that is configured to receive and/or transmit data from/to another device, such as, for example, a storage device 110, patient terminal 130, and/or the like. In some example embodiments, the communication interface 214 is at least partially embodied as or otherwise controlled by the processor 200. In this regard, the communication interface 214 may be in communication with the processor 200, such as via a bus. The communication interface 214 may include, for example, an antenna, a transmitter, a receiver, a transceiver and/or supporting hardware or software for enabling communications with another computing device. The communication interface 214 may be configured to receive and/or transmit data using any protocol that may be used for communications between computing devices. As an example, the communication interface 214 may be configured to receive and/or transmit data using any protocol and/or communications technology that may be used for communicating over the network 108. The communication interface 214 may additionally be in communication with the memory 212, and/or user interface 216, such as via a bus.

The user interface 216 may be in communication with the processor 200 to receive an indication of user input (e.g., via user input 220) and/or to provide an audible, visual (e.g., via display 218), tactile, or other output to a user. As such, the user interface 216 may include a keyboard user input, a mouse, a joystick, a display 218 which may be a touch screen display, a microphone, a speaker, and/or other input/output mechanisms. The user interface may be implemented to provide a healthcare provider with an interface with an electronic health record and to enable modification of at least portions thereof.

According to various embodiments described herein, the healthcare provider apparatus 120 and patient terminal 130 may be embodied by any of a variety of devices, such as a desktop computer, laptop computer, mobile device (e.g., cell phone, personal digital assistant, tablet computer, etc.), or any device capable of providing for presentation of an electronic health record or information elements contained therein. As will be detailed further below, the type of device used to access the electronic health record and information elements contained therein may, at least in part, provide a context for the viewing of the information elements.

As will be described in further detail below, the healthcare provider apparatus 120 may provide several services in order to facilitate the provision of network-accessible patient health records in accordance with various example embodiments. The healthcare provider apparatus 120 may serve as an access arbiter to facilitate maintaining the security of electronic health record documents stored in the storage device 110. In this regard, in some example embodiments, the healthcare provider apparatus 120 functions as an authority responsible for credentialing and certifying participating entities' identities for authentication exchanges. For example, the healthcare provider apparatus 120 may be configured to authenticate a healthcare provider seeking access to a patient's electronic health record document that may be stored in the storage device 110 to ensure that the healthcare provider has access permissions for viewing at least a portion of the patient's medical data. It will be appreciated that any appropriate authentication protocol considered sufficiently strong to protect security of patient's electronic health record documents may be used for authentication of a healthcare provider. By way of example, any authentication protocol used for authentication in commercial business-to-business interactions may be used.

Further attendant to its security functions, in some example embodiments, the healthcare provider apparatus 120 may assume management of a Public Key Infrastructure (PKI) that may be used to facilitate provisioning of encryption and/or decryption keys (e.g., symmetric keys) to service providers publishing and/or accessing patient health record documents. In some example embodiments, the healthcare provider apparatus 120 may be configured to manage the provisioning of healthcare providers and/or other entities of the system 100 with their public key certificates that may be used for secure information exchange, such as exchange of symmetric keys between the healthcare provider apparatus 120 and storage device 110.

While the schematic illustration of FIG. 2 is described with respect to a healthcare provider apparatus 120, the schematic illustration of FIG. 2 can similarly represent a patient terminal 130 configured for accessing patient electronic health records in a similar manner. A patient terminal 130 may require similar security protocols as the healthcare provider apparatus 120; however, the security provisions may be tailored to a patient's personal device that can enable single-session login security protocols or any sufficiently secure interface with the patient's healthcare record.

As described above, example embodiments described herein provide dynamic display of patient data from an electronic health record, such as on display 218 of user interface 216. The dynamic display is contingent upon a context including the identity, role, device type, and authority of the person viewing the electronic health record. According to one embodiment, a patient may wish to view information within his/her own electronic health record, such as on patient terminal 130. An electronic healthcare record may contain a plurality of information elements ranging from patient identifying information to patient diagnoses, patient treatments, and longitudinal patient history information. The elements of an electronic health record that may be of interest to a patient (e.g., a first subset of information elements of the plurality of information elements) may include information such as identifying information (e.g., name, address, contact information, contact preferences, etc.). Other information that a patient may wish to review may include current prescription information, number of available refills, dosage information, drug interaction information, doctor recommended treatments or therapies, etc. Patients may further review an electronic health record for test results from tests such as blood tests (e.g., cholesterol, white-cell count, liver function, etc.), bacterial cultures (e.g., strep throat test), or other such tests. Patients may also wish to review diagnoses, future appointment schedules, recommended future procedures (e.g., mammogram, colonoscopy, body skin scan, etc.). According to example embodiments, a patient may access his/her electronic health record through a dynamic user interface in order to view these informational elements.

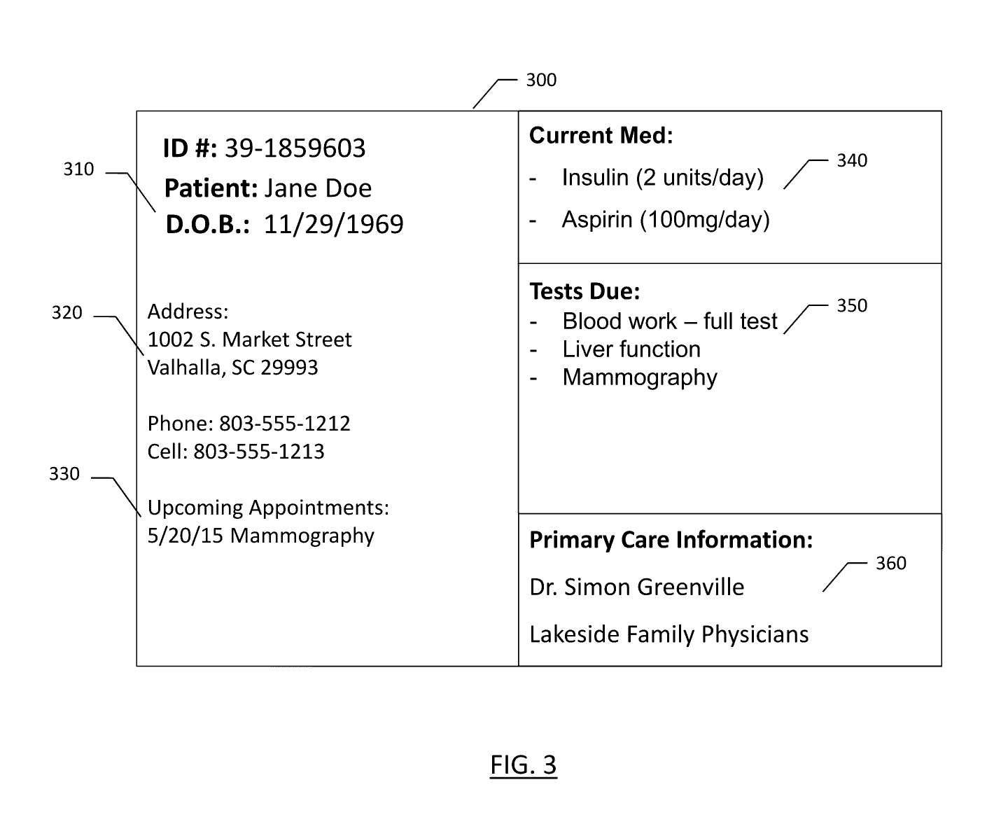

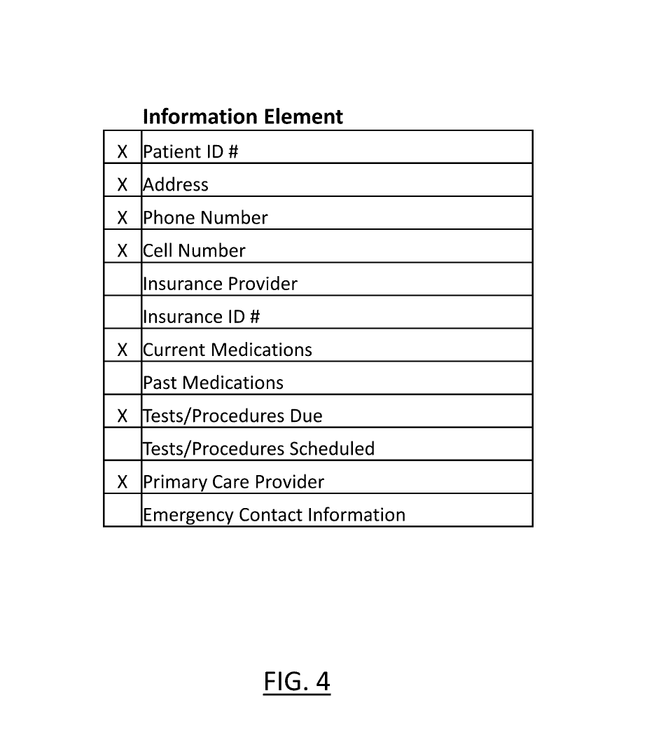

FIG. 3 illustrates an example embodiment of a patient's view 300 of his/her personal electronic health record. This view 300 may be presented, for example, on a display 218 of patient terminal 130. As shown, the example patient's view includes identifying information 310, patient contact information 320, upcoming appointments 330, current medications 340, tests/procedures due 350, and primary care provider information 360. Other information may be available for display, such as insurance information, and may be displayed on an additional page or out of view of the current view 300, accessible via scrolling. The information provided may be user-selectable from a plurality of information elements available to a patient for selection. FIG. 4 illustrates an example illustration of an information element selection view. A user may be provided a plurality of available information elements based on the role (i.e., patient), for example on user interface 216, from which he/she may select those which he/she wishes to be provided for viewing in his/her view of his/her electronic health record. The information elements available for selection may be a subset of all of the information elements of an electronic health record based on the role of the user. Further, the user may select a subset of the available, role-based subset of information elements of the total information elements in the electronic health record. Some information elements not available to the patient role may be deemed inappropriate for patient to view in his/her view of an electronic health record. For example, information elements indicating potential and unconfirmed diagnoses may not be beneficial for a patient to view such that an information element containing potential and unconfirmed diagnoses may not be among the available subset of information elements for patient view.

In order for a patient to view his/her electronic health record (e.g., on display 218), a patient may provide user-identifying login information together with a password or biometric identifier (e.g., via user input 220 of user interface 216) in order to authenticate his/her identity for secure, authorized viewing of his/her personal electronic health record. While the aforementioned information may be of interest to a patient for review of his/her personal electronic health record, a healthcare provider such as a physician may have other priorities and wish to view different information elements of a patient's electronic health record.

According to some embodiments, a healthcare provider (e.g., physician, nurse, etc.) may access a patient's electronic health record at healthcare provider apparatus 120 for review or for periodic monitoring. The healthcare provider may provide user-identifying login credentials and an authenticating password or biometric identifier (e.g., via user input 220 of user interface 216) in order to identify the user as an authorized healthcare provider who is authorized to view a specific patient's electronic health record. This authorization may be established, for example, by a patient upon becoming a patient at a healthcare organization with which the healthcare provider is associated. The patient may grant authorization to one or more providers at the healthcare organization, and may grant authorization to other individuals of the healthcare organization that require access to the patient's electronic health record to provide proper care (e.g., scheduling assistants, etc.). According to some embodiments, authorization may be afforded to an organization, such as a healthcare system including hospitals, doctors, and specialists associated with that system. A healthcare provider outside of an approved healthcare organization may require separate authorization from a patient in order to view the patient's electronic health record, or an authorized healthcare provider may grant proxy authorization as appropriate.

Healthcare providers that view a patient's electronic health record may have differing priorities from the patient such that a healthcare provider may wish to view information elements different from those of particular interest to a patient. Accordingly, in response to an authorized healthcare provider accessing a patient's electronic health record, the healthcare provider may be provided a different subset of the plurality information elements available based on his/her role. Further, the subset of the plurality of information elements available may vary in dependence upon the identity of the authorized healthcare provider. The role and identity may serve as the context in the interactive, context-sensitive electronic health record interface.

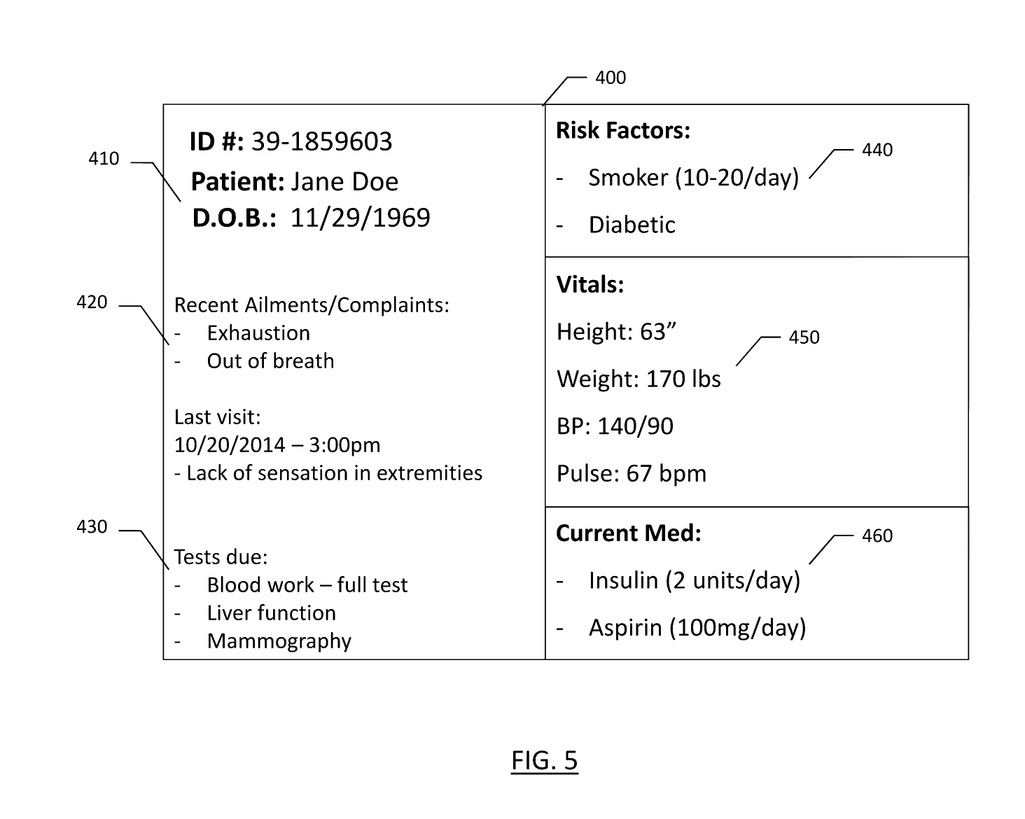

In response to an authorized healthcare provider of a first identity (e.g., a person's primary care physician) being identified and authenticated for review of a patient's electronic health record, the authorized healthcare provider of the first identity may be provided with view 400 of a subset of information elements from the plurality of information elements available in the person's electronic medical record, as illustrated in FIG. 5. The subset of information elements may include information such as patient identifying information 410, recent ailments/complaints 420, tests due 430, risk factors 440, vital statistics 450, and current medications 460. Other information elements, such as recent blood work results, recent diagnoses, chronic conditions, or the like, may also be available and may be depicted on another page, accessible via scrolling, or available through “drilling down” on an information element as described further below.

According to some embodiments, the healthcare provider of the first identity may customize his/her view of a patient's electronic health record. For example, a general practitioner may wish to organize his/her view via user interface 216 of healthcare provider apparatus 120 to clearly see the risk factors for a patient, such as risk factors 440 of view 400. Other healthcare providers may prioritize vital statistics ahead of other information elements such that vital statistics are given a prominent position in the display 400. The subset of information elements available for selection by a healthcare provider role for inclusion in their view of a patient's electronic health record may be different from the subset of information elements available for selection by a patient role. Further, subsets of information elements available for selection for inclusion in a healthcare provider's view may be different from information elements available for selection for inclusion in another healthcare provider's view.

According to an example embodiment, a patient's primary care physician may be authorized to access a patient's electronic health record. That may grant the primary care physician access to most information elements available associated with that patient. However, the patient's primary care physician may not be authorized to access a patient's mental health related information elements, such as mental health diagnoses or symptoms. Similarly, a mental health practitioner role may be authorized to access a patient's electronic health record, but may not be authorized to view a patient's vital statistics or other patient information elements available to his/her primary care physician. Authorization for access to various information elements associated with a patient's electronic health record may be granted by a patient, even if the patient him/herself does not have authorization to view the information elements in a patient role-view of his/her own electronic health record. For example, using the example of an information element containing probable but unconfirmed diagnoses, the patient may authorize both a primary care physician and a mental health provider to view this information element in his/her respective electronic health record views in order to better understand a patient's condition.

While the aforementioned examples describe healthcare provider roles generally as physicians, healthcare provider roles may also include nurses, scheduling assistants, insurance claims adjusters, and other healthcare providers that may not require detailed information from a patient's electronic health record. For example, a scheduling assistant may not require any information from a patient's electronic health record beyond the patient's identification number, name, and/or date of birth. More sensitive information, such as medications, diagnoses, etc., may not be pertinent to the scheduling assistant's role such that when a scheduling assistant accesses a patient's electronic health record, he/she may be presented with only the information relevant to his/her role. The scheduling assistant's identifying login information into healthcare provider apparatus may inform the system of the role of the viewer and preclude presentation of information elements that the viewer is not authorized to access. Similarly, a nurse may require only a limited view of a patient's electronic health record depending upon that nurses role. Information element access can be determined based on an individual's role, or the specific identification of a unique individual. For example, a first nurse may have access to a first subset of information elements of a patient's electronic health record while a second nurse may have authorization to access a second, different subset of information elements of that patient's electronic health record.

According to some embodiments, certain users may have administrative privileges such that they can assume the role of any healthcare provider or any subset of healthcare providers in order to review a patient's electronic health record from the perspective of another viewing role. For example, a physician may be treating a patient with a very sensitive and complex condition. The physician may want nurses and staff to have only limited information with respect to the condition. The physician may be able to view the patient's electronic health record from the view of a nurse or a staff member role. In this way, access to a patient's electronic health record may include a hierarchical structure whereby a primary care physician may have full access to the record and may also view the health record from the perspective of any other user role (e.g., patient, nurse, scheduling assistant, etc.). Similarly, a nurse, who may be lower on the hierarchy than a physician, but higher than a scheduling assistant, may be able to view the health record from the perspective of a scheduling assistant role, but not from the physician's role.

In addition to using the role of a user, the identity of the user, and the authority of the user, an additional context may be used to establish the information elements available for view. The device type used by a user accessing an electronic health record may help determine the information elements available for a user to view. For example, some devices used to access an electronic health record, such as a portable device or smart phone, may not be able to adequately display certain graphical elements of a patient's electronic medical record for proper interpretation by a user. A radiology study may not be available on a portable device or smart phone as an accurate radiology read may not be able to be conducted reliably on such a device. Further, portable devices that may be located outside of a healthcare facility such as a tablet computer or smart phone, may be precluded from displaying highly sensitive information, such as social security number or billing information as these devices may be inadvertently made visible to unauthorized users (e.g., a person sitting beside an authorized user on public transportation). In this manner, the device type may help define the information elements available for an authorized user to view. In the same manner, the connection type of the device may help establish the information elements available for a user. A user accessing an electronic health record through a network access point outside of a healthcare organization network (e.g., a coffee shop WiFi connection), may be limited in the information elements available for viewing based on the potential for unauthorized viewing of the information elements.

As described above, example embodiments may provide for dynamic display of information elements of a patient's electronic health record based on the identity, device type, and/or role(s) of the person accessing the record. The information elements of an electronic health record may contain semi-structured data that can be aligned to modeling using graph vertices and edges. Using a combination of graph query and view transforms, a multitude of representations can be generated that provide context-sensitive, relevant details of an electronic health record that a viewer is interested in based on the viewer's role.

Electronic health records have information elements or data points like health history (personal, past, family, etc.) diagnoses, medications, allergies, vital data, etc., as described above. Each of these data elements may be illustrated as a node of a graph, with each of these information nodes being associated with a specific patient, and each information node representing a unique information element about the patient. These information nodes create the dynamic, layered graph-based electronic health record enabling information to be readily available to users of various roles such that they do not need to wade through excess or ancillary information. Users will not suffer from cognitive overload trying to map relevant and irrelevant details. As care scenarios change and care provider roles vary, dynamic views of the layered, graph-based electronic health record may also change.

There may be various roles of healthcare providers who contribute to, view, and modify the patient's electronic health record. Roles such as patient, physician, nurse, paramedic, emergency medical staff, scheduling staff, counselors, etc. Each role or individual within a role may be able to view and navigate a patient's electronic health record for relevant information elements. Each identity of a healthcare provider or the patient may have a unique login at a healthcare provider apparatus 120. Upon logging in and identifying a patient whose record is sought (e.g., via user interface 216), the interactive, context-sensitive electronic health record interface may identify (e.g., via processor 200) the permitted profile of the user (e.g., nurse, physician, etc.), identify a query associated with that permitted profile, and generate a view of the patient's electronic health record for presentation on display 218. The query may be performed over a graph model of the information nodes (i.e., information elements) of the graph that are bound to the view for the user.

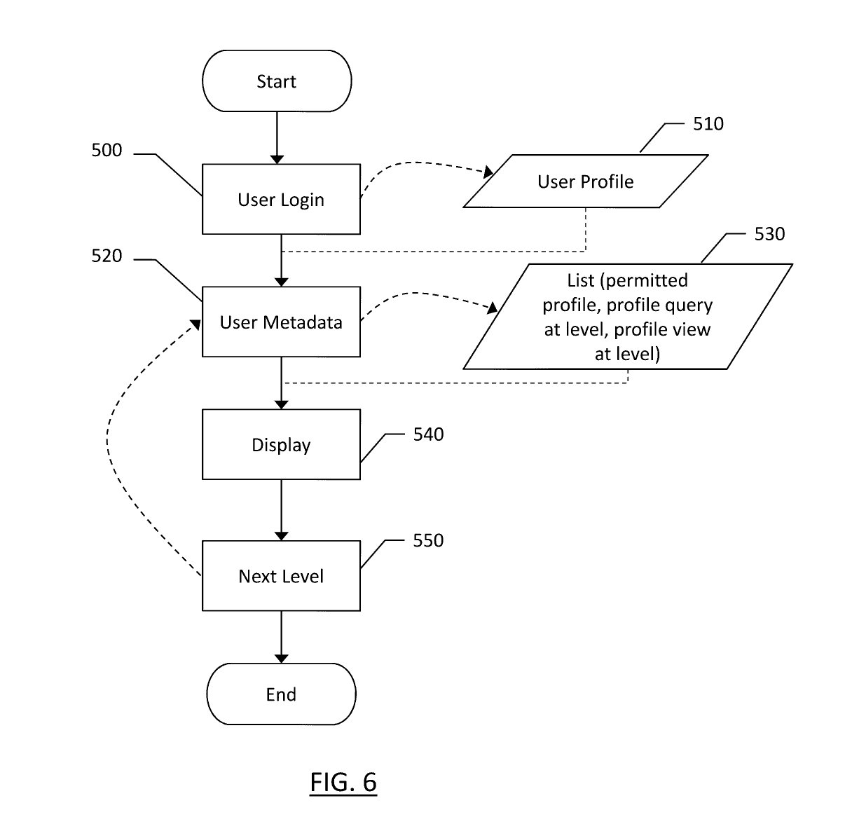

FIG. 6 illustrates a flow chart of a method for providing for an interactive, context-sensitive interface with an electronic health record. The method begins with a user login at 500, from which a user profile is obtained at 510 which defines the user's role and identity. This login may be performed via user interface 216 of the healthcare provider apparatus 120. While an electronic health record may include a plurality of information elements, each represented in example embodiments by an information node, these information nodes may have associations with various roles based on their relevancy to the role. In some cases, information available to a user of a particular role may be limited to information nodes associated with the respective role, while other information nodes are either inaccessible or are hidden (i.e., available by “drilling down” on related information nodes). The user profile is then used at 520 to obtain user metadata (e.g., via processor 200) which may define: a) lists of the user's permitted profile; b) query; and c) views at 530. Permitted profiles may be hierarchical and role driven, and/or may be additive or ad hoc without an established hierarchy. For example, a nurse's profile is subsumed by a physician's profile in a hierarchical role driven embodiment. Thus, a physician may assume a nurse's profile and review the electronic health record from a nurse's view; however, a nurse may not review an electronic health record from a physician's view. In an ad hoc embodiment, the permitted profiles may be established for a specific purpose, such as a radiology read order. In such an ad hoc embodiment, the authorized radiologist may be able to access the profiles of any other role, but this access may be limited to when an active radiology read order is required or requested. The metadata may list the permitted profiles available for viewing within the user's profile. A physician's list of permitted profiles may include, beyond the physician's own profile, a specific specialist (e.g., radiologist), a nurse, a pharmacist, a scheduling assistant, and the patient profile view. A nurse's list of permitted profiles beyond the nurse's own profile, may include a pharmacist and a scheduling assistant.

The query defined in the metadata may include a query of information nodes and may be limited to the information nodes available for any given role. Said differently, each role may have a corresponding set of information nodes to which a user having that role has access. The query may be limited to this set of information nodes. The query of the information nodes associated with the role of the user or the user's selected profile may result in a first subset of the information nodes associated with the role of the user. This first subset may be the information nodes that are determined, either by rules, user settings (e.g., as described above in relation to FIG. 4), historical use, or a combination thereof, to be of interest or benefit to the user. In other words, for example, the query may result in only those subset of nodes of particular interest to the user. The rules, user settings, and historical use, may be stored locally, for example on memory 212 of the healthcare provider apparatus, or stored in the metadata of the electronic health record on storage device 110. The view that is defined in the metadata may be a template that defines how to present the first subset of information nodes to the user at 540 on display 218.

A user may change his/her profile via user interface 216 to another permitted profile, such as when a physician may change his/her profile view to that of a nurse. In such an embodiment, the method may revert to 520 to confirm that the nurse profile view is permitted, and establish a query based on the nurse profile. The query is generated of information nodes associated with the nurse role and a subset of the information nodes associated with the nurse role may be returned. The information nodes may be presented at the display at 540 according to the view associated with the permitted profile.

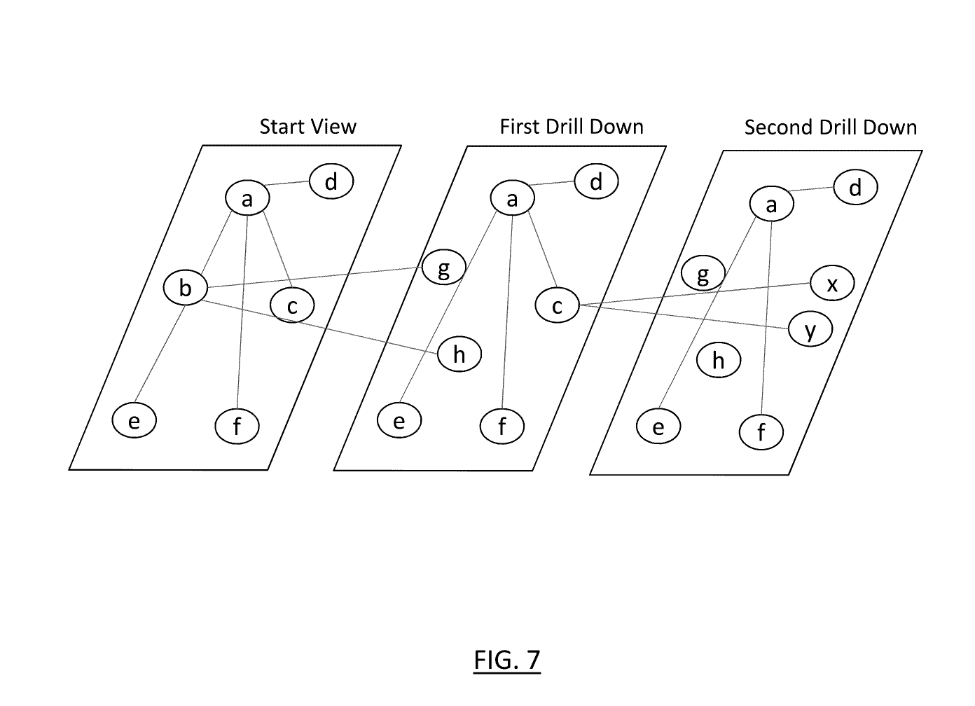

The information elements of a patient's electronic health record represented by information nodes may be modeled in a graphical model of nodes. FIG. 7 depicts a graphical representation of a sample graph node model for an interactive, context-sensitive electronic health record interface. The “start view” of FIG. 7 may represent an initial view of a patient's electronic health record, such as the view illustrated in FIG. 5. A user, such as a physician, may “drill down” into an information element or “node” such as node “b” of FIG. 7, which may represent a person's “recent ailments/complaints” shown as element 420 of FIG. 5. Upon drilling down into this node, the physician user may be presented with information elements identified by nodes “g” and “h”, which may be more detailed information or additional information related to the “recent ailments/complaints.” The information available in nodes “g” and “h” may be privileged for viewing by a physician, and not available to a user such as a nurse or a patient. For example, the physician may have noted in a prior visit that the recent ailments/complaints included one or more ailments that appeared to be psychosomatic. This diagnosis may be detrimental to a patient as they may perceive an actual issue, such that the diagnosis of psychosomatic complaints may be available only to the physician in the “first drill down” view shown in FIG. 7. Similarly, the physician user may drill down into node “c” which contains information elements represented by nodes “x” and “y” of the second drill down.

The Second Drill Down of FIG. 7 may contain nodes “a”, “d”, “e”, “f”, g″, “h”, “x”, and “y”, that are established as the information nodes desired by a user with a role, such as physician. While the information nodes of the Start View may be high-level information, the information nodes of the Second Drill Down may represent the informational elements needed by the physician to properly treat the patient. As such, the query for the user may be modified such that upon logging in, the initial query run will perform the first and second drill down steps initially, and present the information associated with the information nodes of the Second Drill Down as the initial view for the physician. This may save the physician from having to navigate through excess information and may improve efficiency and quality of care. This ability to “drill down” may enable a viewer to zoom-in and zoom-out of the patient information graph allowing summarized, detailed, and mized representations of patient information elements or nodes on a single screen or view.

While the above-described embodiments include individual electronic health records that may be interacted with in unique interfaces that are dependent upon the role of the individual accessing them, according to some embodiments, users may access a plurality of electronic health records for purposes of reviewing patient information across a population of patients.

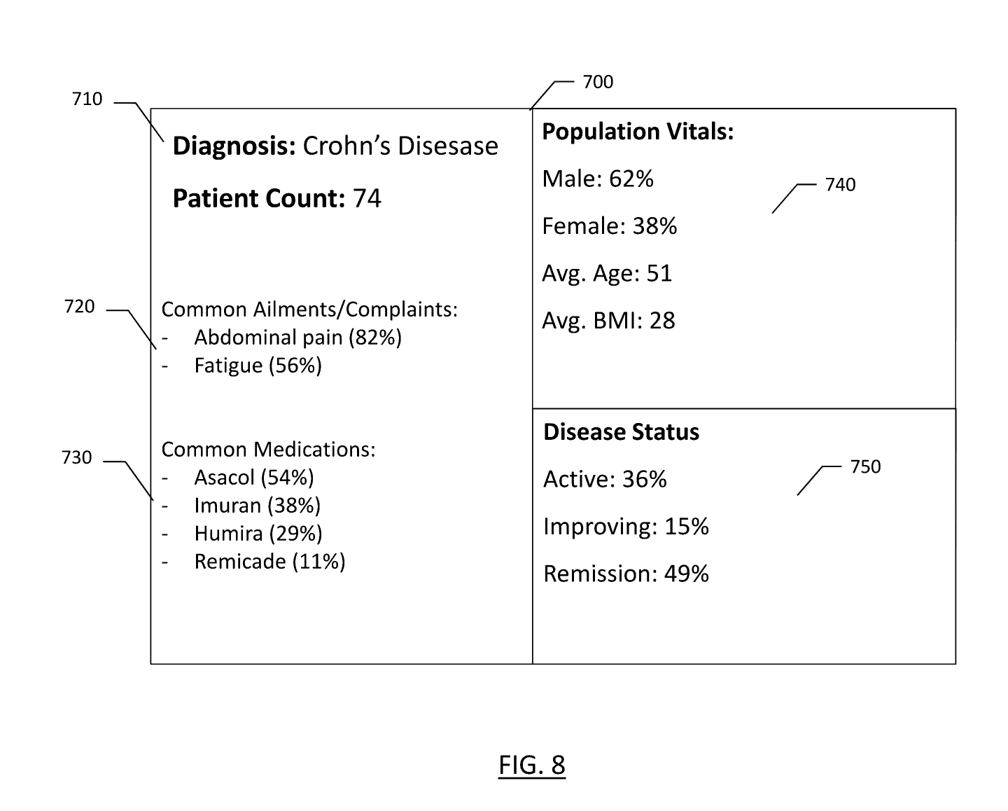

A physician may access a plurality of patients under his/her care to determine trends, treatments, outcomes, etc. According to an example embodiment, a physician may request access to the electronic medical records of a group of his/her patients that are diagnosed with a particular disease. For example, a gastroenterologist may wish to review the population of his/her patients with Crohn's Disease. FIG. 8 illustrates an example embodiment of a summary electronic medical record view 700 indicating the selected diagnosis 710 and the patient count having the selected diagnosis. Information available to the physician from the individual electronic medical records of the patients for which the physician has authorized access may be presented in summary form for the population requested. In the illustrated embodiment, common ailments/complaints 720 of the patient may be displayed along with common medications 730 taken by the patient population. Further, average population vitals 740 and disease status 750 of the patient may be indicated for review by the physician. This electronic medical record summary being an extension of the electronic medical record view of an individual patient as applied to a population. The physician may “drill down” into any particular element of information to arrive at an individual patient electronic medical record as necessary for evaluation of the patient and the population.

Embodiments in which the electronic healthcare records of a plurality of patients or a population are being reviewed, the information may be accessed much in the same manner that it is for an individual patient. An authorized healthcare provider may log in to a population of electronic health records with a user role and profile, as shown in FIG. 6. The information nodes may be accessed for each of the plurality of patients in order to be summarized as illustrated in the population view of FIG. 8. The role of the user and the identity may determine the permitted profiles, the query, and the views of the user. However, the views may include population-related information rather than patient-specific information.

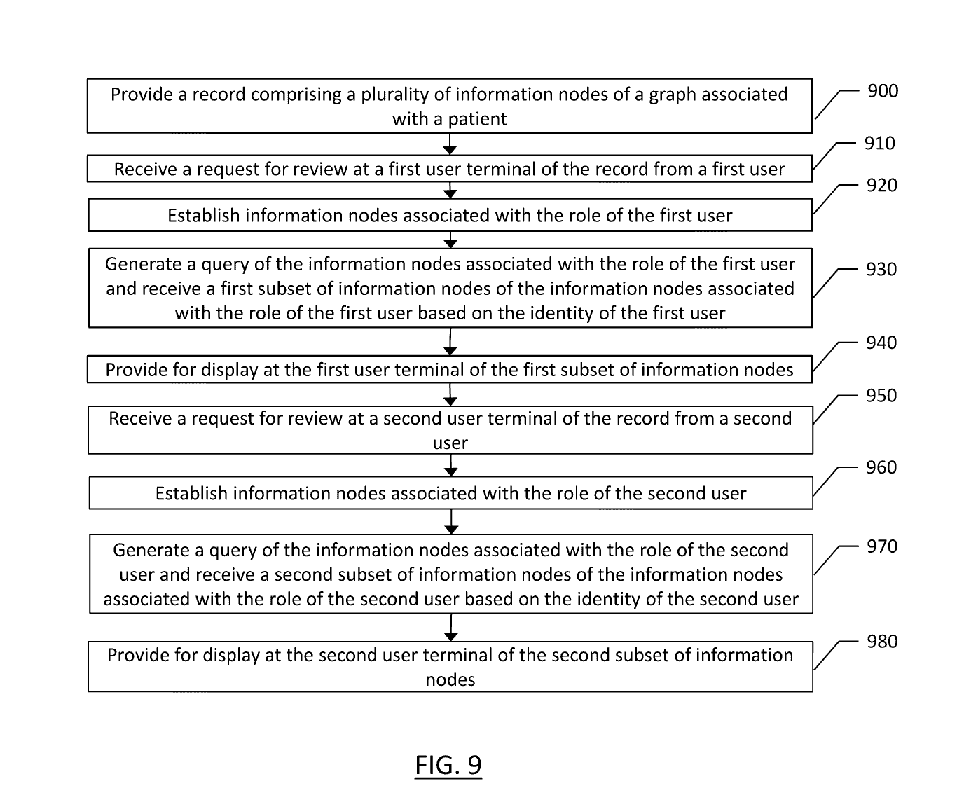

FIG. 9 illustrates a flowchart according to an example method for providing an interactive, context-sensitive electronic health record interface according to some example embodiments. In this regard, FIG. 9 illustrates a method that may be performed at a healthcare provider apparatus 120 or a patient terminal 130. The operations illustrated in and described with respect to FIG. 9 may, for example, be performed by, with the assistance of, and/or under the control of one or more of the processor 200, memory 212, communication interface 214, or user interface 216. At operation 900, a patient record comprising a plurality of information nodes of a graph associated with the patient may be provided. A request for review of the record may be received at 910 from a first user at a first user terminal via user interface 216. Information nodes associated with the role of the first user, such as physician, nurse, etc., may be established at 920 via processor 200. A query may then be generated by processor 200 of the information nodes associated with the role of the first user such that a first subset of information nodes of the information nodes associated with the role of the first user may be received based on the identity of the first user at 930. The first subset of information nodes may be provided for display on display 218 at the first user terminal at 940. Another request for review from a second user may be received at 950 by user interface 216. Nodes may be established by the processor 200 based on the role of the second user at 960. A query may be generated by the processor 200 of the information nodes associated with the role of the second user and a second subset of information nodes of the information nodes associated with the role of the second user may be received at 970 based on the identity of the second user. The second subset of information nodes may be provided for display on display 218 at the second user terminal at 980.

As described above, FIG. 9 illustrates a flowchart of a system, method, and computer program product according to example embodiments of the invention. It will be understood that each block of the flowcharts, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by one or more memory devices of a server, desktop computer, laptop computer, mobile computer, or other computing device (e.g., healthcare provider apparatus 120 or the like) and executed by a processor (e.g., the processor 200). In some embodiments, the computer program instructions comprising the computer program product(s) which embody the procedures described above may be stored by memory devices of a plurality of computing devices. As will be appreciated, any such computer program product may be loaded onto a computer or other programmable apparatus to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product comprises an article of manufacture which implements the function specified in the flowchart block(s). The computer program instructions of one or more computer program products may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks or steps of the flowcharts support combinations of means for performing the specified functions and combinations of steps for performing the specified functions. It will also be understood that one or more blocks of the flowcharts, and combinations of blocks in the flowcharts, may be implemented by special purpose hardware-based computer systems which perform the specified functions or steps, or combinations of special purpose hardware and computer program product(s).

The above described functions may be carried out in many ways. For example, any suitable means for carrying out each of the functions described above may be employed to carry out embodiments of the invention. In one embodiment, a suitably configured processor may provide all or a portion of the elements of the invention. In another embodiment, all or a portion of the elements of the invention may be configured by and operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. An electronic health record interaction system for providing an interactive, context-sensitive electronic health record interface, the system comprising at least one processor, wherein the at least one processor is configured to cause the system to at least:
provide a record comprising a plurality of information nodes of a graph associated with a patient;
receive a request for review at a first user terminal of the record from a first user having a first identity;
establish information nodes associated with a role of the first user;
generate a query of the information nodes associated with the role of the first user and receive a first subset of [jm1] the information nodes associated with the role of the first user based, at least in part, on the identity of the first user;
provide for display at the first user terminal of the first subset of information nodes;
receive a request for review at a second user terminal of the record from a second user having a second identity;
establish information nodes associated with a role of the second user;
generate a query of the information nodes associated with the role of the second user and receiving a second subset of the information nodes associated with the role of the second user based on the identity of the second user; and
provide for display at the second user terminal of the second subset of information nodes, wherein the first subset of information nodes is different from the second subset of information nodes.

2. The electronic health record interaction system of claim 1, wherein the processor is further configured to cause the system to:
enable the first user to edit one or more of the first subset of information nodes and enable the second user to edit one or more of the second subset of information nodes.

3. The electronic health record interaction system of claim 2, wherein the processor is further configured to cause the system to:
preclude the first user from editing one or more of the second subset of information nodes and preclude the second user from editing one or more of the first subset of information nodes.

4. The electronic health record interaction system of claim 1, wherein each information node comprises an informational element about the patient, wherein the first subset of information nodes comprises one or more of current prescriptions for the patient, contact information for the patient, or future physician appointments for the patient.

5. The electronic health record interaction system of claim 4, wherein the second subset of information nodes comprises one or more of laboratory results for the patient, diagnoses for the patient, or vital physiological statistics of the patient.

6. The electronic health record interaction system of claim 1, wherein the first subset of information nodes is established based on relevance to the first user role and the first user identity.

7. The electronic health record interaction system of claim 1, wherein the processor is further configured to cause the system to:
enable the first user to select a second role;
establish information nodes associated with the second role;
generate a query of the information nodes associated with the second role to determine a third subset of information nodes of the information nodes associated with the second role based, at least in part, on the identity of the first user; and
provide for display at the first user terminal of the third subset of information nodes.

8. A method for providing an interactive, context-sensitive electronic health record interface, the method comprising:
providing a record comprising a plurality of information nodes of a graph associated with a patient;
receiving a request for review at a first user terminal of the record from a first user having a first identity;
establishing information nodes associated with a role of the first user;
generating a query of the information nodes associated with the role of the first user and receiving a first subset of the information nodes associated with the role of the first user based, at least in part, on the identity of the first user;
providing for display at the first user terminal of the first subset of information nodes;
receiving a request for review at a second user terminal of the record from a second user having a second identity;
establishing information nodes associated with a role of the second user;
generating a query of the information nodes associated with the role of the second user and receiving a second subset of the information nodes associated with the role of the second user based, at least in part, on the identity of the second user; and
providing for display at the second user terminal of the second subset of information nodes, wherein the first subset of information nodes is different from the second subset of information nodes.

9. The method of claim 8, further comprising:
enabling the first user to edit one or more of the first subset of information nodes and enabling the second user to edit one or more of the second subset of information nodes.

10. The method of claim 9, further comprising:
precluding the first user from editing one or more of the second subset of information nodes and precluding the second user from editing one or more of the first subset of information nodes.

11. The method of claim 8, wherein each information node comprises an informational element about the patient, wherein the first subset of information nodes comprises one or more of current prescriptions for the patient, contact information for the patient, or future physician appointments for the patient.

12. The method of claim 11, wherein the second subset of information nodes comprises one or more of laboratory results for the patient, diagnoses for the patient, or vital physiological statistics of the patient.

13. The method of claim 8, wherein the first subset of information nodes is established based on relevance to the first user role and the first user identity.

14. The method of claim 8, further comprising
enabling the first user to select a second role;
establishing information nodes associated with the second role;
generating a query of the information nodes associated with the second role to determine a third subset of information nodes of the information nodes associated with the second role based, at least in part, on the identity of the first user; and
providing for display at the first user terminal of the third subset of information nodes.

15. A computer program product for providing network-accessible patient health records, the computer program product comprising at least one non-transitory computer-readable storage medium having computer-readable program instructions stored therein, the computer-readable program code instructions comprising:
program code instructions for providing a record comprising a plurality of information nodes of a graph associated with a patient;
program code instructions for receiving a request for review at a first user terminal of the record from a first user having a first identity;
program code instructions for establishing information nodes associated with a role of the first user;
program instructions for generating a query of the information nodes associated with the role of the first user and receiving a first subset of the information nodes associated with the role of the first user based, at least in part, on the identity of the first user;
program code instructions for providing for display at the first user terminal of the first subset of information nodes;
program code instructions for receiving a request for review at a second user terminal of the record from a second user having a second identity;
program code instructions for establishing information nodes associated with a role of the second user;
program code instructions for generating a query of the information nodes associated with the role of the second user and receiving a second subset of the information nodes associated with the role of the second user based, at least in part, on the identity of the second user; and
program code instructions for providing for display at the second user terminal of the second subset of information nodes, wherein the first subset of information nodes is different from the second subset of information nodes.

16. The computer program product of claim 15, further comprising:
program code instructions for enabling the first user to edit one or more of the first subset of information nodes and program code instructions for enabling the second user to edit one or more of the second subset of information nodes.

17. The computer program product of claim 16, further comprising:
program code instructions for precluding the first user from editing one or more of the second subset of information nodes and program code instructions for precluding the second user from editing one or more of the first subset of information nodes.

18. The computer program product of claim 15, wherein each information node comprises an informational element about the patient, wherein the first subset of information nodes comprises one or more of current prescriptions for the patient, contact information for the patient, or future physician appointments for the patient.

19. The computer program product of claim 18, wherein the second subset of information nodes comprises one or more of laboratory results for the patient, diagnoses for the patient, or vital physiological statistics of the patient.

20. The computer program product of claim 15, further comprising:
program code instructions for enabling the first user to select a second role;
program code instructions for establishing information nodes associated with the second role;
program code instructions for generating a query of the information nodes associated with the second role to determine a third subset of information nodes of the information nodes associated with the second role based, at least in part, on the identity of the first user; and
program code instructions for providing for display at the first user terminal of the third subset of information nodes.
